(19) United States
(12) Patent Application Publication
(10) Pub. No.: US 2016/0062488 A1
(43) Pub. Date: Mar. 3, 2016

(54) THREE-DIMENSIONAL AIR MOUSE AND DISPLAY USED TOGETHER THEREWITH

(71) Applicant: MEMSIC, INC., Andover, MA (US)

(72) Inventors: Yang Zhao, Andover, MA (US); Michael Sun, Fayetteville, NY (US)

(21) Appl. No.: 14/631,058

(22) Filed: Feb. 25, 2015

Related U.S. Application Data
(60) Provisional application No. 62/044,329, filed on Sep. 1, 2014.

(51) Int. Cl. G06F 3/0354; G09G 5/18; G06F 3/01

(52) U.S. Cl. CPC G06F 3/03543; G06F 3/017; G09G 5/18

(57) ABSTRACT

An air mouse system is described. The air mouse is configured to periodically transmit RF signals in order to trigger a plurality of ultrasonic transmitters arranged on a television. The ultrasonic transmitters transmit ultrasonic signals when being triggered by the RF signals from the RF trigger. An ultrasonic receiver receives the ultrasonic signals. A processor calculates a location of the air mouse with respect to the ultrasonic transmitters based on time differences of the ultrasonic signals transmitted by the ultrasonic transmitters arriving at the ultrasonic receiver. A series of locations of the air mouse forms a motion trail of the air mouse and the air mouse transmits the motion trail to the television wirelessly. The motion trail is projected as a cursor trail on the television screen by the television, to control the cursor on the television screen by virtue of the motion of the air mouse.

### STATEMENT REGARDING FEDERALLY SPONSORED RESEARCH OR DEVELOPMENT

N/A

### BACKGROUND

Various embodiments relate generally to smart television systems, methods, devices and computer programs and, more specifically, relate to man-machine interaction interface and motion remote control.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

With the continuous improvement in television networking functionalities and the gradual shift into an era of smart televisions, the development of novel man-machine interfaces and remote controllers has been led along a path of persistence.

Services that continually grow along with the networking functionalities bring more complexity to list selection—a traditional menu that features the functions of up, down, left, right, and OK buttons has become out-of-date for normal use, but offering an excessively-complex menu could lead to troublesomeness and slowness in remote controller's operations. So far three universal man-machine interface solutions have emerged under the joint efforts of many television manufacturers and brands: Speech Recognition, Gesture Recognition and Motion Sensing.

In terms of speech recognition, the addition of the speech recognition function has a significant impact upon the diversity of television products, and the reason for that is that a larger number of intricate dialects and local accents exist in various different regions.

As for gesture recognition, it has been proven by game machines that gesture recognition is commercially available, however, gesture control is unsuitable for many web pages, especially those requiring delicate and precise mouse movement. Also, gesture recognition is not perceived as an excellent ergonomic design, indicating that fatigue is likely to affect the stretching ability and posture of an arm. Furthermore, motions in gesture recognition are normally captured by a camera arranged in the front of the television, and many people are not willing to have a camera mounted on the television they watch every day, especially a television that can be connected to the Internet.

Motion capture, also known as remote point, is considered to be a technology that is developing rapidly at present. And the smallest hindrance to its application could be found on televisions, for the reason that a computer mouse, touch pad or Wii-type controller has been widely accepted and acquainted by consumers when it comes to computer usage. These motion capture (remote point) devices, however, are also much more expensive than ordinary remote controllers, turning their high cost into a major obstacle to their extensive application.

What is needed is man-machine interfaces and remote controllers which overcome the problems facing existing approaches, such as, cost, privacy concerns, etc.

### BRIEF SUMMARY

The below summary is merely representative and non-limiting.

The above problems are overcome, and other advantages may be realized, by the use of various embodiments.

Being regarded as one type of remote point, the air mouse in accordance with various embodiments can not only address the cost issue existing in traditional remote controllers, but also furnishes greater simplicity and easiness in operation. Moreover, the air mouse is applicable for both two-dimensional and three-dimensional (3D) smart television display systems, and is further endowed with a spatial orientation function.

In general, various embodiments provide an air mouse. An ultrasonic transmitter array is fixedly mounted (such as around a display) and transmits ultrasonic signals. The times of the ultrasonic signals arriving at an ultrasonic receiver on the air mouse is based on the relative location of the air mouse to the transmitters. The location of the air mouse is determined based on the times of the ultrasonic signals arriving at the air mouse. Alternatively, the air mouse may transmit the ultrasonic signals which are received by an ultrasonic receiver array.

In a first aspect, an embodiment provides a method to control a cursor. The method includes, in response to a trigger signal, transmitting one or more ultrasonic signals (for example, from an air mouse). The one or more ultrasonic signals is received (for example, at the mouse when the television transmits the ultrasonic signals triggered by the trigger signal). The method includes determining a location of a mouse based on a distance each ultrasonic signal traveled. The method also includes displaying a cursor on a screen based at least in part on the location of the mouse.

In a further aspect, an embodiment provides a mouse to control a cursor. The mouse includes a radio frequency transmitter configured to transmit a trigger signal, one or more ultrasonic receivers configured to receive a plurality of ultrasonic signals, one or more processors; and one or more memories storing computer program code. The one or more memories and the computer program code are configured, with the one or more processors, to cause the apparatus to perform actions. The actions include transmitting the trigger signal at a first time, receiving the plurality of ultrasonic signals, each ultrasonic signal having an associated arrival time, and for each ultrasonic signal received, determining a distance the ultrasonic signal traveled based on a difference of the first time and the associated arrival time. The actions also include determining a location of a mouse based on the distance each ultrasonic signal traveled; and transmitting location information regarding the location of the mouse (for example, to a television so that it can display a cursor).

In another aspect, an embodiment provides a television to control a cursor, the television includes a screen configured to display a cursor, a radio frequency receiver configured to receive a trigger signal from a mouse; one or more ultrasonic transmitters configured to transmit a plurality of ultrasonic signals; one or more processors; and one or more memories storing computer program code. The one or more memories and the computer program code are configured, with the one or more processor, to cause the apparatus to perform actions. The actions include receiving the trigger signal at a first time and, in response to receiving the trigger signal, transmitting the plurality of ultrasonic signals at approximate the same time. The actions also include receiving location information regarding the location of the mouse; converting the location information regarding the location of the mouse into a display location for the cursor; and displaying the cursor at the display location.

### BRIEF DESCRIPTION OF THE SEVERAL VIEWS OF THE DRAWINGS

Aspects of the described embodiments are more evident in the following description, when read in conjunction with the attached Figures.

FIG. 1 is a schematic diagram showing a 3D air mouse according to a first embodiment.

FIG. 2 is a schematic diagram showing the 3D air mouse according to a second embodiment.

FIG. 3 shows a block diagram of a device that is suitable for use in practicing various embodiments.

FIG. 4 shows a block diagram of another device that is suitable for use in practicing various embodiments.

FIG. 5 illustrates a cursor being displayed at a first location in accordance with a further embodiment.

FIG. 6 illustrates the cursor being displayed at a second location in accordance with the further embodiment.

FIG. 7 is a schematic diagram showing a TV accessory device that is suitable for use in practicing various embodiments.

FIG. 8 is a schematic diagram showing a TV with a built-in device that is suitable for use in practicing various embodiments.

FIG. 9 is a logic flow diagram illustrating a method, and a result of execution of computer program instructions embodied on a memory, in accordance with an embodiment.

### DETAILED DESCRIPTION

This patent application claims priority under 35 U.S.C. §119(e) from U.S. Provisional Patent Application No. 62/044,329, filed Sep. 1, 2014, the disclosure of which is incorporated by reference herein in its entirety.

One of the features, benefits and advantages of various embodiments is to provide techniques for controlling a cursor using an air mouse. Additional objects, features, and advantages will become apparent upon examining the following detailed description, taken in conjunction with the attached drawings.

According to one embodiment, an air mouse is provided which includes a radio frequency (RF) trigger configured for transmitting RF signals. These RF signals may be used to periodically trigger a plurality of ultrasonic transmitters arranged on a television. The ultrasonic transmitters transmit ultrasonic signals when triggered by the RF signals from the RF trigger. An ultrasonic receiver receives the ultrasonic signals transmitted by the ultrasonic transmitters arranged on the television. A processor calculates a location of the air mouse with respect to the ultrasonic transmitters based on times that the ultrasonic signals transmitted by the ultrasonic transmitters arrive at the ultrasonic receiver. A series of locations of the air mouse can be used to form a motion trail of the air mouse. The air mouse transmits the motion trail to the television wirelessly, and the motion trail is projected as a cursor trail on the television screen by the television.

In a further embodiment, the air mouse may include at least two ultrasonic receivers operating on the same or different frequencies. The at least two ultrasonic receivers are separated by a certain distance. A rotation of the mouse can also be deduced from a calculation of different trails of the ultrasonic receivers, for example, by calculating the 3D location of each ultrasonic receiver separately using at least three ultrasonic transmitters arranged on the television. Using this information, the orientation of the mouse may be determined.

In another alternative embodiment, there may be at least three ultrasonic transmitters arranged on the television. The RF trigger transmits RF signals with the same or different frequencies, and the individual ultrasonic transmitters can be triggered by these RF signals. The propagation velocity of the RF signal is much higher than that of the ultrasonic signal. Thus, the time difference of the RF signals transmitted to different locations is negligible with respect to the time difference of ultrasonic wave signal transmitted to different locations. The RF signals transmitted by the air mouse can be assumed to arrive at different ultrasonic transmitters simultaneously, e.g., the ultrasonic transmitters are triggered at the same time.

The air mouse may be a part of a smart phone, e.g., the air mouse is replaced by the smart phone. Both the motion condition and motion trail information of the air mouse are converted into the motion and trail of a screen cursor, so as to remotely control the cursor.

An air mouse may also consist of devices that have ultrasonic transmitting and receiving functions. Ultrasonic waves with are transmitted by the air mouse and then reflected by an active or passive ultrasonic reflector arranged around the smart screen. The spatial location of the air mouse is derived by calculating the time difference of ultrasonic waves reflected by different reflectors, thus in the same way, the goal of controlling the cursor by virtue of the air mouse is achieved.

According to another embodiment, a television system with an air mouse includes a plurality of ultrasonic receivers fixedly mounted around the television screen. The system is also connected to a television electrically, outputting electric signals to the television, such as when receiving ultrasonic signals. The air mouse transmits a RF signal and ultrasonic signals synchronously and periodically. The smart television is triggered by the RF signals to begin receiving the electric signals from ultrasonic receivers mounted around the television screen when the ultrasonic receivers receive the ultrasonic waves transmitted by the air mouse. A processor on the television calculates the location of the air mouse based on the time the ultrasonic waves are detected by the different ultrasonic receivers. A series of locations of the air mouse forms a motion trail of the air mouse which can then be displayed on the television screen.

### First Embodiment

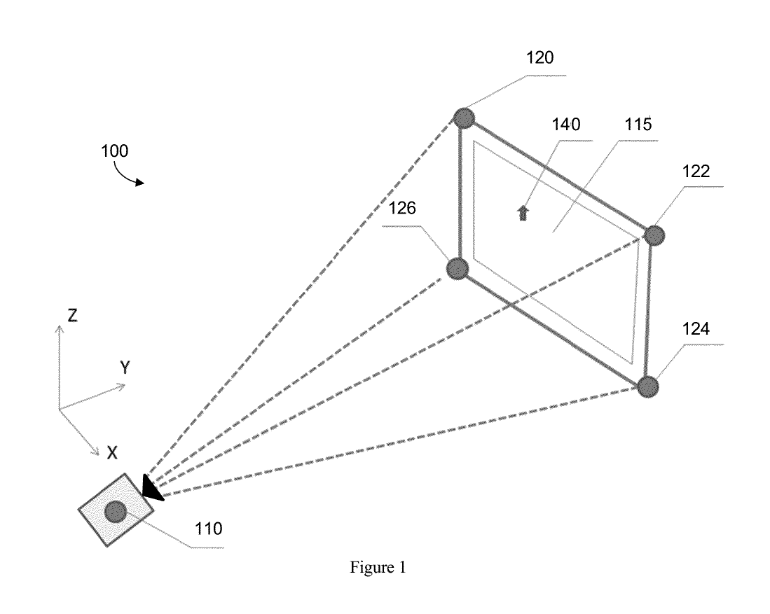

FIG. 1 is a schematic diagram showing a 3D air mouse according to the first embodiment. System 100 includes the mouse 110, which is capable of periodically transmitting RF ultrasonic trigger signals and simultaneously receiving ultrasonic signals. Ultrasonic transmitters 120, 122, 124, 126 are positioned around the television screen 115. A cursor 140 is displayed on the television screen 115. In accordance with this embodiment, the location of the mouse 110 is used to determine where to display the cursor 140. The motion condition and motion trail information of the air mouse are converted into the motion and trail of a screen cursor, so as to remotely control the cursor.

In one non-limiting modification, a receiving function is added to the ultrasonic transmitters 120, 122, 124, 126 arranged around the smart screen 115 and an ultrasonic reflection function is added to the air mouse 110. In that way, the ultrasonic signals with different phases are created to scan the space by controlling different ultrasonic transmitters to transmit the ultrasonic signals at different times. The air mouse 110 is located by the system 100 depending on the change of reflection strength, and then tracking of the air mouse 110 is achieved via a feedback system.

The propagation velocity of the RF signal is much higher than that of the ultrasonic waves and both the RF signal and the ultrasonic signals are transmitted by the air mouse 110 simultaneously. Therefore, with the television receiving the RF signal from the air mouse 110, the starting time for the air mouse 110 to transmit/receive the ultrasonic waves can be set for the television.

In one non-limiting embodiment, the mouse 110 is a 3D air mouse. The 3D air mouse 110 works through the following steps:
1) Three or more ultrasonic transmitters 120, 122, 124, 126 are fixedly mounted around a television screen 115. Each ultrasonic transmitter 120, 122, 124, 126 is triggered by a RF signal to transmit an ultrasonic signal.
2) The air mouse 110 has a RF trigger transmitting RF signals periodically, and an ultrasonic receiver receiving the ultrasonic signals from the ultrasonic transmitters 120, 122, 124, 126. The propagation velocity of the RF signal is much higher than that of the ultrasonic signal. Thus, the time difference of the RF signals transmitted to different locations is negligible with respect to the time difference of ultrasonic wave signals transmitted to different locations. That is to say, the RF signals transmitted by the air mouse 110 can be assumed to arrive at different ultrasonic transmitters 120, 122, 124, 126 simultaneously, e.g. the ultrasonic transmitters are triggered at the same time.
3) The RF signals are periodically transmitted by the air mouse 110 while in motion to trigger the ultrasonic transmitters 120, 122, 124, 126. Thus, the air mouse 110 receives a group of ultrasonic signals after each RF signal is transmitted. The location of the air mouse 110 with respect to these ultrasonic transmitters 120, 122, 124, 126 at that moment can be calculated according to the time of the ultrasonic signals arriving at the air mouse 110. A motion trail of the air mouse 110 is generated based on a series of continuous locations of the air mouse 110.
4) The motion trail of the air mouse 110 is wirelessly transmitted to the smart television.
5) The motion trail is projected as a cursor trail on the television screen 115 by the smart television. This allows the user to control the cursor 140 on the television screen by virtue of the motion of the air mouse 110.

In one modification of this embodiment, two ultrasonic receivers are fixed on the air mouse 110. These receivers are separated by a certain distance. This allows the system to deduce a rotation of the air mouse 110 based on the different trails of the two ultrasonic receivers.

In another modification of this embodiment, the air mouse 110 may have both ultrasonic transmitting and receiving functions. Ultrasonic waves with different frequencies are transmitted by the air mouse 110 and then reflected by active or passive ultrasonic reflectors arranged around the smart screen (replacing or supplementing the transmitters 120, 122, 124, 126). The spatial location of the air mouse 110 is derived by calculating the time of ultrasonic waves reflected by different reflectors; thus, controlling of the cursor 140 by virtue of changing the location of the air mouse 110.

A method is provided for calculating the spatial location of the mouse 110 based on the time of the ultrasonic receiver array 120, 122, 124, 126 at fixed locations receiving the ultrasonic signals transmitted by the mouse 110. Since the ultrasonic signals travel at the same speed, the distance of the mouse 110 from each receiver 120, 122, 124, 126 can be calculated based on how long the ultrasonic signal takes to reach the mouse 110. Using this information, the location of the mouse 110 may be determined geometrically, for example, by using trilateration techniques. The mouse's location may then be converted into a position for the cursor 140. Relative changes to the mouse's location may then be translated into similar changes to the position of the cursor 140, such as, moving the mouse 110 to the left by a foot may be translated to a movement of the cursor 140 to the left of the screen 115 (either by the same distance or by some adjusted distance).

### Second Embodiment

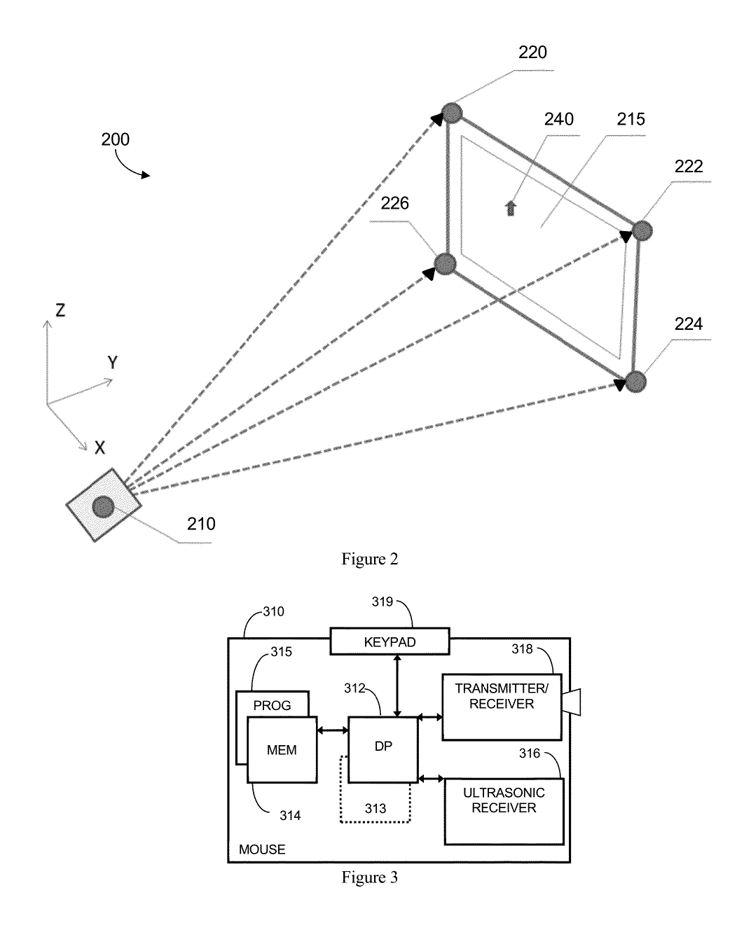

FIG. 2 is a schematic diagram showing a system 200 according to the second embodiment. System 200 includes the mouse 210, which is capable of periodically transmitting RF signals and ultrasonic signals. Receivers 220, 222, 224, 226 are configured to receive the ultrasonic signals from the mouse 210 and are positioned around the television screen 215. The receivers 220, 222, 224, 226 are also configured to transmit electric signals converted from the ultrasonic signals to a controller, such as for the television and/or a set-top box. A cursor 240 is displayed on the television screen 215. In accordance with this embodiment, the location of the mouse 210 is used to determine where to display the cursor 240.

The 3D air mouse 210 provided in this embodiment works through the following steps:
1) Three or more ultrasonic receivers 220, 222, 224, 226 are fixedly mounted around the television screen 215, are connected with the television electrically. The ultrasonic receivers 220, 222, 224, 226 output electric signals to the television when the ultrasonic signals are received.
2) Both an RF signal and ultrasonic signals are synchronously transmitted by the air mouse 215. The smart television is triggered by the RF signals to begin receiving the electric signals from the ultrasonic receivers 220, 222, 224, 226 arranged around the television screen 215. The electric signals are generated when the ultrasonic receivers 220, 222, 224, 226 receive the ultrasonic waves transmitted by the air mouse 210.
3) The propagation velocity of the RF signal is much higher than that of the ultrasonic waves and the RF signal and the ultrasonic signals are transmitted by the air mouse 210 simultaneously. Therefore, with the television receiving the RF signal from the air mouse 210, the starting time for the air mouse 210 to transmit the ultrasonic waves can be set on the television.
4) The times for the ultrasonic receivers 220, 222, 224, 226 at different locations to receive the ultrasonic signals transmitted by the air mouse 210 are different. Meanwhile, the time for converting the ultrasonic waves into the electric signals and transmitting the electric signals to the television is negligible relative to the transmission time for the ultrasonic waves. The difference of the time for the television to receive the electric signals from different ultrasonic receivers 220, 222, 224, 226 is nearly equal to the difference of the time for the ultrasonic receivers 220, 222, 224, 226 to receive the ultrasonic signals transmitted by the air mouse 210.
5) The time difference of the electric signals from different ultrasonic receivers 220, 222, 224, 226 is equivalent to the time difference of receptions of ultrasonic signals transmitted by the air mouse 210. Thus, the location of the mouse 210 can be deduced.
6) The motion trail of the air mouse 210 can be calculated by receiving the RF signals and the ultrasonic signals and periodically transmitted by the air mouse 210 in motion.
7) The motion condition and motion trail of the air mouse 210 are converted by the television into the motion and trail of the screen cursor 240, so as to enable controlling the cursor 240 on the television screen 215 by virtue of the motion of the air mouse 210.

In one embodiment, a transmitting function is added to the ultrasonic receivers 220, 222, 224, 226 arranged around the smart screen 215 and an ultrasonic reflection function is added to the air mouse 210. In that way, the ultrasonic signals with different phases are created to scan the space by controlling different ultrasonic transmitters to transmit the ultrasonic signals at different times. The air mouse 210 is located depending on the change of reflection strength, and then tracking of the air mouse 210 is achieved via a feedback system.

The 3D air mouse 210 consists of a RF-triggered ultrasonic device and an ultrasonic receiving device. An array ultrasonic transmitters 220, 222, 224, 226 arranged in the vicinity of the smart screen 215 (television screen, flat-plate display screen, etc.) are synchronously triggered by an RF signal from the mouse 210. The location of the mouse 210 is deduced by calculating the time difference of receptions of the ultrasonic waves transmitted by the array ultrasonic receivers 220, 222, 224, 226. Ultrasonic waves are ceaselessly triggered by the mouse 210 in motion so that the motion condition and 3D motion trail of the mouse 210 can be obtained, and the motion condition and motion trail information of the mouse 210 are reflected onto a smart screen via a cursor 214 of the screen. This enables controlling the cursor 240 of the smart screen 215 by virtue of the 3D motion of the mouse 210. This 3D air mouse 210 is not only applicable for 3D cursor control, for example, the mouse 210 may be used for 2D displays (for example, by ignoring the y-axis).

Two RF transmitters of different frequencies, which are separated by a certain distance, may be fixed on the mouse 210, and the rotation of the mouse 210 can then be deduced from calculation of different trails of the two triggers.

The mouse 210 may also consist of devices that possess an ultrasonic transmitting and receiving function. Ultrasonic waves of difference frequencies are transmitted by the mouse 210 and then reflected by an active or passive ultrasonic reflector (replacing or supplementing the receivers 220, 222, 224, 226) arranged in the vicinity of the smart screen 215. The spatial location of the mouse 210 is derived from calculating the time difference of different reflector ultrasonic waves received after transmission of the mouse 210, thus in the same way, the purpose of controlling the cursor 240 by virtue of the mouse 210 is realized.

The motion condition and motion trail information of the air mouse 210 are converted into the motion and trail of a screen cursor 240, so as to remotely control the cursor 240.

In one non-limiting embodiment, a transmitting function is added to the ultrasonic receivers 220, 222, 224, 226 arranged around the smart screen 215 and an ultrasonic reflection function is added to the air mouse 210. In that way, the ultrasonic signals with different phases are created to scan the space by controlling different ultrasonic transmitters to transmit the ultrasonic signals at different times. The air mouse 210 is located by the system depending on the change of reflection strength, and then tracking of the air mouse 210 is achieved via a feedback system.

FIG. 3 shows a block diagram of a device that is suitable for use in practicing various embodiments. The mouse 310 includes a controller, such as a data processor (DP) 312, a computer-readable medium embodied as a memory (MEM) 314 that stores computer instructions, such as a program (PROG) 315, and suitable wireless communication interfaces, such as an ultrasonic receiver 316 and transmitter/receiver 318. The mouse 310 may also include a keypad 319 and/or a dedicated processor, for example, a location determining chip 313.

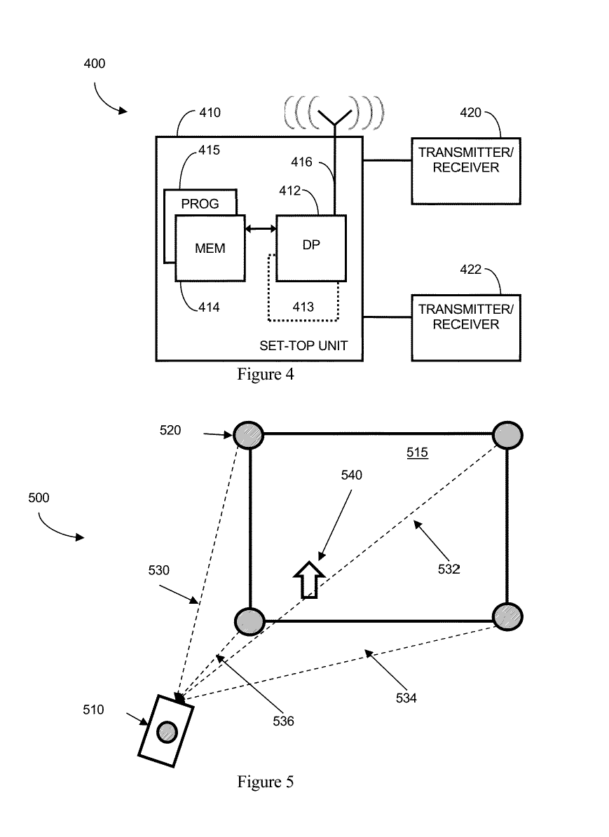

FIG. 4 shows a block diagram of a system 400 that is suitable for use in practicing various embodiments. The system 400 incorporates a set-top unit 410 and various transmitters/receivers 420, 422. The set-top unit 410 includes a controller, such as a data processor (DP) 412, a computer-readable medium embodied as a memory (MEM) 414 that stores computer instructions, such as a program (PROG) 415, and suitable wireless communication interfaces, such as an RF receiver 416. The set-top unit 410 also operates with the transmitters/receivers 420, 422 in order to receive/send wireless signals (such as ultrasonic signals). The set-top unit 410 may also include a dedicated processor, for example, a mouse location determining chip 413.

The transmitters/receivers 420, 422 may be embodied in a display unit (such as a television), embodied in the set-top unit 410, and/or embodied in sensors located externally to the display unit. While two transmitters/receivers 420, 422 are shown, the system 400 may incorporate additional transmitters/receivers.

The programs 315, 415 may include program instructions that, when executed by the associated DPs 312, 412 enable the mouse 310 and set-top unit 410 to operate in accordance with an embodiment. That is, various embodiments may be carried out at least in part by computer software executable by the DP 312 of the mouse 310, the DP 412 of the set-top unit 410, by hardware of the mouse 310/set-top unit 410, or by a combination of software and hardware.

In general, various embodiments of the mouse 310 may include television remote controllers, cable box remote controllers, cellular telephones, tablets, gaming devices, music players, as well as other devices that incorporate combinations of such functions.

In general, various embodiments of the set-top unit 410 may include a processing unit embodied in a television, a cable box, a gaming system, as well as other devices that incorporate combinations of such functions.

The MEMs 314, 414 may be of any type suitable to the local technical environment and may be implemented using any suitable data storage technology, such as magnetic memory devices, semiconductor based memory devices, flash memory, optical memory devices, fixed memory and removable memory. The DPs 312, 412 may be of any type suitable to the local technical environment, and may include general purpose computers, special purpose computers, microprocessors and multicore processors, as non-limiting examples. The wireless communication interface (e.g., transmitter/receiver 318, RF receiver 416, etc.) may be of any type suitable to the local technical environment and may be implemented using any suitable communication technology such as RF systems, including the use of optical communication systems, such as infrared systems and/or optical scanning systems, RF communication systems, or a combination of such components. Additionally, the communication interface may be a bidirectional interface using transmitters, receivers, and/or transceivers, or, as appropriate for the embodiment, a unidirectional interface.

FIG. 5 illustrates a cursor being displayed at a first location in accordance with a further embodiment. As shown, the mouse and display are in a first system state 500. The mouse is located as a first mouse position 510 relative to the screen 515. Transmitters 520 each produce ultrasonic signals 530, 532, 534, 536. These signals 530, 532, 534, 536 are then received at the mouse and the first mouse position 510 is determined. Based on the determined first mouse position 510, a cursor is displayed at a first cursor position 540.

At one non-limiting embodiment, the amount of time taken by each ultrasonic signal 530, 532, 534, 536 to travel from the associated transmitter 520 to the mouse may be determined. This information may then be used to determine the distance the between the first mouse position 510 and the associated transmitter 520. For example, based on the time the first signal 530 is received at the mouse, the distance between the first mouse position 510 and the associated transmitter 520 can be calculated using the known speed of ultrasonic signals. Combining the distance information for each ultrasonic signal 530, 532, 534, 536 enables the first mouse position 510 to be determined within a 3D environment.

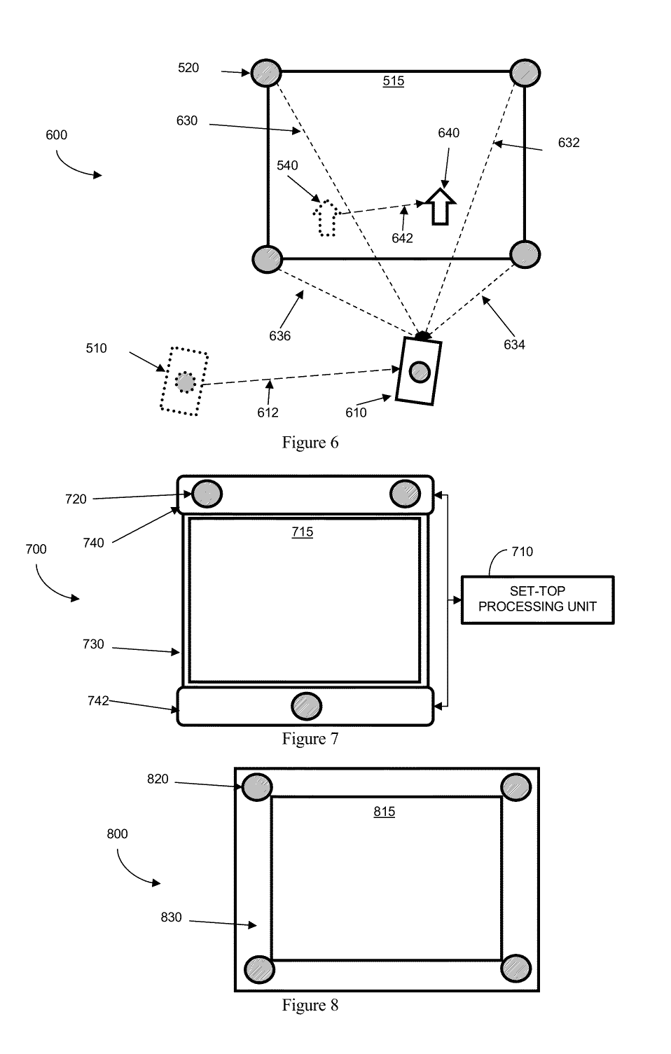

FIG. 6 illustrates the cursor being displayed at a second location in accordance with the further embodiment. As shown in the second system state 600, the mouse has been moved from the first mouse position 510 to the second mouse position 610. This is highlighted as change in mouse position 612.

In the second mouse position 610, the mouse receives each ultrasonic signal 630, 632, 634, 636 from the associated transmitter 520. Due to the change in mouse position 612, the ultrasonic signals 630, 632, 634, 636 arrive with a different time delay. As before, this information is used to determine the second mouse position 610. This information is then used to display the cursor at the second cursor position 640 which is shifted from the first cursor position 540 by a change in cursor position 642.

In one non-limiting embodiment, the change in mouse position 612 is converted to a change in cursor position 642 based on a multiplier. For example, moving the mouse one foot may be converted to a move of 10 inches on the screen 515 or as percentage of the display area (e.g., a move along the x-axis equal to 50% of screen size). Alternatively, the multiplier may be a based on the mouse position, for example, the multiplier may be larger when the mouse is further from the screen 515 along the y-axis than the multiplier would be when the mouse is closer to the screen 515. This allows the position of the cursor to be visually closer to where the user may see the mouse in their view.

In another non-limiting embodiment, the mouse may include additional sensory circuits. While the speed of the movement may be determined based on change of position, the mouse may include additional speed or movement detection sensors. For example, the mouse may include an accelerometer to detect when the mouse has begun moving. This information may be used in order to light up buttons on the mouse and/or to send a RF signal to the transmitter 520 in order to trigger the transmission of the ultrasonic signals so that the location of the mouse may be determined. The accelerometer may be relatively simple in order to avoid the high costs of a more sensitive sensor such as used in gaming remotes.

As seen above, the mouse may include multiple ultrasonic receivers, transmitters or reflectors so that the orientation and rotation of the mouse may also be determined. This data may be used to change the image of the cursor, for example, to reflect the orientation/rotation of the mouse. Alternatively, this information may be used alter the function of the mouse, for example, moving the mouse when held vertically may be interpreted as no change in the position of the cursor so that the user may reposition the mouse. As another non-limiting example, twisting the mouse may be a command to select an option and/or to return to a previous screen/menu.

FIG. 7 is a schematic diagram showing a system 700 that is suitable for use in practicing various embodiments. The system 700 includes a screen 715 which is located within a display housing 730. Located externally to the display housing 730 are a first sensor housing 740 above the display housing 730 and a second sensor housing 742 below the display housing 730. Each sensor housing 740, 742 includes one or more transmitters/receivers 720. In the non-limiting embodiment shown, the first sensor housing 740 has two transmitters/receivers 720 and the second sensor housing 742 has one transmitter/receiver 720. The sensor housings 740, 742 are connected to set-top processing unit 710. Using the at least three transmitters/receivers 720 the set-top processing unit 710 is able to determine the location of a mouse in 3D.

In further non-limiting embodiments, the system 700 may include additional transmitters/receivers 720. The additional transmitters/receivers 720 may be included in the sensor housings 740, 742 and/or provided in additional sensor housings. Alternatively, a single sensor housing may embody both sensor housings 740, 742.

In additional non-limiting embodiments, the sensor housings 740, 742 may be located in different arrangements, for example, one or both of the second sensor housings 740, 742 may be positioned along the side of the display housing 730. Alternatively, the sensor housings 740, 742 may be positioned further from the display housing 730, such as, embedded in a wall or incorporated into a speaker system.

In further non-limiting embodiments, the set-top processing unit 710 may be embodied in the display housing 730, in a remote device (such as a video recorder or a cable box), or within one or both of the sensor housings 740, 742.

As described above, the mouse may send an RF signal in order to trigger the ultrasonic signals from transmitters/receivers 720. In one non-limiting embodiment, the set-top processing unit 710 receives an indication that the RF signal (either from any one of the transmitters/receivers 720 or from an additional sensor). The set-top processing unit 710 can then instruct the transmitters/receivers 720 to begin transmission of the ultrasonic signals.

Alternatively, each transmitters/receivers 720 may include circuitry to automatically begin transmission of an ultrasonic signal upon receiving the RF signal. When the delay of the transmitters/receivers 720 to respond is sufficiently short, the ultrasonic signal may be considered as transmitted at the same as the RF signal. In that case, the time the ultrasonic signal takes to propagate (or travel) between the transmitters/receivers 720 and the mouse may be determined as the difference between the time the RF signal is transmitted by the mouse and the time the ultrasonic signal is received by the mouse.

In a further alternative embodiment, the mouse may be configured to transmit another, relatively high-speed signal in order to trigger the relatively low-speed ultrasonic signals; for example, the mouse may transmit an infrared (IR) trigger signal.

FIG. 8 is a schematic diagram showing a system 800 that is suitable for use in practicing various embodiments. In this embodiment, the system 800 is a TV with built-in transmitters/receivers 820. The transmitters/receivers 820 are located within the display housing 830 and arranged around the screen 815. As shown, the transmitters/receivers 820 are adjacent to the screen 815. In further embodiments, the transmitters/receivers 820 and the screen 815 may overlap in part or in whole, for example, one or more of the transmitters/receivers 820 may be located completely behind the screen 815.

As described above, various embodiments provide a method, apparatus and computer program(s) to control a cursor using 3D motion.

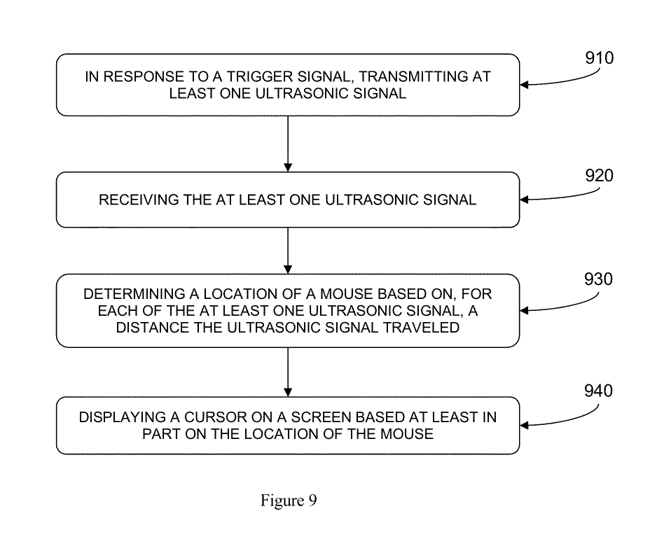

FIG. 9 is a logic flow diagram that illustrates a method, and a result of execution of computer program instructions, in accordance with various embodiments. In accordance with an embodiment a method performs, at Block 910, a step of in response to a trigger signal, transmitting at least one ultrasonic signal. The at least one ultrasonic signal is received at Block 920. At Block 930, the method performs a step of determining a location of a mouse based on a distance the ultrasonic signal traveled for each of the at least one ultrasonic signal. The method also performs a step of displaying a cursor on a screen based at least in part on the location of the mouse at Block 940.

The various blocks shown in FIG. 9 may be viewed as method steps, as operations that result from use of computer program code, and/or as one or more logic circuit elements constructed to carry out the associated function(s).

An embodiment provides a mouse for controlling a cursor using 3D motion. The mouse includes a RF transmitter configured to periodically transmit RF signals to a plurality of ultrasonic transmitters arranged on a television. When triggered by the RF signals the ultrasonic transmitters transmit ultrasonic signals. The mouse also includes an ultrasonic receiver configured to receive the ultrasonic signals. A processor calculates a location of the air mouse with respect to the ultrasonic transmitters based on when the ultrasonic signals arrive at the ultrasonic receiver. A series of locations of the air mouse forms a motion trail of the air mouse. The air mouse wirelessly transmits the motion trail to the television, and the motion trail is projected as a cursor trail on the television screen.

In a further embodiment of the mouse above, the air mouse includes at least two ultrasonic receivers with different frequencies. These ultrasonic receivers are separated by a certain distance and a rotation of the mouse can be deduced from the calculation of different trails of the ultrasonic receivers.

In another embodiment of any one of the mice above, there are at least two ultrasonic transmitters.

In a further embodiment of any one of the mice above, the RF transmitter transmits RF signals with different frequencies. The ultrasonic transmitters can be triggered by the RF signals with different frequencies. For example, one RF signal at a first frequency triggers a single ultrasonic transmitter (or a set of ultrasonic transmitters) and a second RF signal at a second frequency triggers a different ultrasonic transmitter (or a different set of ultrasonic transmitters).

In another embodiment of any one of the mice above, the propagation velocity of the RF signal is much higher than that of the ultrasonic signal. Thus, the arrival times of when the RF signals arrive at different locations is negligible with respect to the arrival times of when the ultrasonic wave signals arrive at different locations. That is to say, the RF signals transmitted by the air mouse can be assumed to arrive at different ultrasonic transmitters simultaneously such that the ultrasonic transmitters are considered to be triggered at the same time.

In a further embodiment of any one of the mice above, the air mouse may be a part of a smart phone, e.g. the air mouse is replaced by the smart phone.

In another embodiment of any one of the mice above, the motion and motion trail information of the air mouse are converted into the motion and trail of a screen cursor, so as to remotely control the cursor.

An additional embodiment provides a mouse for controlling a cursor using 3D motion. The mouse is configured to provide ultrasonic transmitting and receiving functions. Ultrasonic waves with difference frequencies are transmitted by the air mouse and then reflected by an active or passive ultrasonic reflector arranged around the smart screen. The spatial location of the air mouse is derived by calculating the transit time of the ultrasonic waves reflected by the different reflectors. This information is then used to determine the location of the mouse and to control a cursor accordingly. Thus, the cursor may be controlled by virtue of the air mouse.

A further embodiment provides a television system for controlling a cursor using 3D motion of an air mouse. The system includes a plurality of ultrasonic receivers fixedly mounted around a television screen and electrically connected with a television. The ultrasonic receivers are configured to output electric signals to the television when receiving ultrasonic signals. The system also includes an air mouse configured to transmit RF signal and ultrasonic signals synchronously and periodically. The smart television is triggered by the RF signals to begin receiving the electric signals from the ultrasonic receivers mounted around the television screen. The electric signals are generated when the ultrasonic receivers receive the ultrasonic waves transmitted by the air mouse. A processor on the television calculates the location of the air mouse based on the electric signals from different ultrasonic receivers (for example, based on when the processor receives the electric signals). A series of locations of the air mouse forms a motion trail of the air mouse.

In another embodiment of the television system above, the motion and motion trail information of the air mouse is converted into a location and motion trail of a screen cursor, so as to remotely control the cursor.

In a further embodiment of any one of the television systems above, the ultrasonic receivers also include a transmitting function. The mouse provides an ultrasonic reflection function (for example, instead of an ultrasonic signal transmission function. Accordingly, the ultrasonic signals with different phase are created by the ultrasonic transmitters to scan the space. The ultrasonic signals are reflected by the mouse and then received by the ultrasonic receivers. The location of the air mouse is determined based on the change of reflection strength.

In another embodiment of any one of the television systems above, the propagation velocity of the RF signal is much higher than that of the ultrasonic waves. The RF signal and the ultrasonic signals are transmitted by the air mouse simultaneously. Therefore, when the television receives the RF signal from the air mouse before receiving the ultrasonic signal. The starting time for the air mouse to transmit the ultrasonic waves can be set on the television such that the difference of the reception time of the RF signal and the reception time of the ultrasonic signal is effectively identical to the amount of time the ultrasonic signal took to travel from the mouse to the ultrasonic receiver.

In a further embodiment of any one of the television systems above, the spatial location of the mouse is calculated based on the arrival time of the ultrasonic signals transmitted by the mouse which received by the ultrasonic receiver array at fixed locations.

In another embodiment of any one of the television systems above, the air mouse may be a part of a smart phone, e.g. the air mouse is replaced by the smart phone.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method to control a cursor, the method comprising:
in response to a trigger signal, transmitting at least one ultrasonic signal;
receiving the at least one ultrasonic signal;
determining a location of a mouse based on, for each of the at least one ultrasonic signal, a distance the ultrasonic signal traveled; and
displaying a cursor on a screen based at least in part on the location of the mouse.

2. The method of claim 1, further comprising:
transmitting the trigger signal from the mouse to a plurality of ultrasonic transmitters,
wherein each of the plurality of ultrasonic transmitters is configured to receive the trigger signal and to transmit the ultrasonic signal in response to receiving the trigger signal.

3. The method of claim 1, wherein the mouse is configured to receive a plurality ultrasonic signals, wherein each ultrasonic signal is transmitted by a separate ultrasonic transmitter.

4. The method of claim 1, wherein determining the location of the mouse comprises:
for each reception of the at least one ultrasonic signal, determining a transit time of the ultrasonic signal received, wherein the transit time is a difference between a time the ultrasonic signal was transmitted and a time the ultrasonic signal was received;
for each of the at least one ultrasonic signal, determining the distance the ultrasonic signal traveled based at least in part on the transit time of the ultrasonic signal and a speed of the ultrasonic signal; and
calculating the location of the mouse using trilateration based on the distance the ultrasonic signal traveled.

5. The method of claim 1, further comprising:
periodically transmitting the trigger signal; and
determining a motion trail based on a plurality of locations of the mouse.

6. The method of claim 1, wherein the trigger signal is a radio frequency trigger signal, and radio frequency signals have a propagation speed much greater than a propagation speed of ultrasonic signals.

7. The method of claim 1, further comprising:
transmitting the trigger signal from the mouse; and
in response to transmitting the trigger signal, transmitting the at least one ultrasonic signal, wherein the trigger signal and the at least one ultrasonic signal are transmitted at approximately a same time.

8. The method of claim 7, wherein receiving the at least one ultrasonic signal comprises receiving the at least one ultrasonic signal using a plurality of ultrasonic transmitters arranged around the screen.

9. The method of claim 7, wherein receiving the at least one ultrasonic signal comprises receiving, at the mouse, reflections of the at least one ultrasonic signal from a plurality of ultrasonic reflectors arranged around the screen.

10. The method of claim 1, further comprising transmitting the trigger signal from the mouse,
wherein transmitting the at least one ultrasonic signal comprises transmitting a plurality of ultrasonic signals each from a different ultrasonic transmitter of a plurality of ultrasonic transmitters arranged around the screen in response to receiving the trigger signal such that the trigger signal and the at least one ultrasonic signal are considered as being transmitted at approximately a same time

11. The method of claim 10, wherein receiving the at least one ultrasonic signal comprises receiving the plurality of ultrasonic signals at the mouse.

12. The method of claim 10, wherein receiving the at least one ultrasonic signal comprises receiving, at the plurality of ultrasonic transmitters, reflections of the at least one ultrasonic signal from at least one ultrasonic reflector in the mouse.

13. The method of claim 1, further comprising transmitting location information regarding the location of the mouse from the mouse to the television.

14. The method of claim 13, wherein location information comprises at least one of: a determined location of the mouse at a given time; a determined transmit time for each of the plurality of ultrasonic signals at a given time; and a motion trail representing a plurality of locations of the mouse at a plurality of times.

15. A mouse to control a cursor, the mouse comprising:
a radio frequency transmitter configured to transmit a trigger signal;
at least one ultrasonic receiver configured to receive a plurality of ultrasonic signals;
at least one processor; and
at least one memory including computer program code,
wherein the at least one memory and the computer program code configured to, with the at least one processor, cause the mouse to perform at least the following comprising:
transmitting the trigger signal at a first time;
receiving the plurality of ultrasonic signals, each ultrasonic signal having an associated arrival time;
for each ultrasonic signal received, determining a distance the ultrasonic signal traveled based on a difference of the first time ant the associated arrival time;
determining a location of a mouse based on the distance each ultrasonic signal traveled; and
transmitting location information regarding the location of the mouse.

16. The mouse of claim 15, wherein the at least one ultrasonic receiver comprises a first ultrasonic receiver and a second ultrasonic receiver; and
the method further comprises determining an orientation of the mouse based on a location of the first ultrasonic receiver and a location of the second ultrasonic receiver.

17. The mouse of claim 15, wherein the mouse is embodied in a smart phone.

18. A television to control a cursor, the television comprising:
a screen configured to display a cursor,
a radio frequency receiver configured to receive a trigger signal from a mouse;
at least one ultrasonic transmitter configured to transmit a plurality of ultrasonic signals;
at least one processor; and
at least one memory including computer program code,
wherein the at least one memory and the computer program code configured to, with the at least one processor, cause the television to perform at least the following comprising:
receiving the trigger signal at a first time;
in response to receiving the trigger signal, transmitting the plurality of ultrasonic signals at approximate the same time;
receiving location information regarding the location of the mouse;
converting the location information regarding the location of the mouse into a display location for the cursor; and
displaying the cursor at the display location.

19. The method of claim 18, wherein location information comprises at least one of: a determined location of the mouse at a given time; a determined transmit time for each of the plurality of ultrasonic signals at a given time; and a motion trail representing a plurality of locations of the mouse at a plurality of times.

20. The television of claim 18, wherein the display is three-dimensional display and wherein converting the location information regarding the location of the mouse into the display location for the cursor comprises converting the location information regarding the location of the mouse into a three-dimensional display location for the cursor.
